(19) United States
(12) Patent Application Publication
(10) Pub. No.: US 2003/0210808 A1
(43) Pub. Date: Nov. 13, 2003

(54) Method and apparatus for organizing and retrieving images containing human faces

(75) Inventors: Lawrence S. Chen, Webster, NY (US); Madirakshi Das, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/143,272

(22) Filed: May 10, 2002

(51) Int. Cl. G06K 9/00

(52) U.S. Cl. 382/118

(57) ABSTRACT

A method of organizing images of human faces in digital images into clusters, comprising the steps of: locating images of human faces in the digital images using a face detector; extracting the located human face images from the digital images; and forming clusters of the extracted human face images, each cluster representing an individual using a face recognizer.

### FIELD OF THE INVENTION

The present invention is in the field of image organization and retrieval, with particular emphasis on organizing and retrieving images containing human faces.

### BACKGROUND OF THE INVENTION

Photographs containing human faces are perhaps the most treasured in people's collection of photographs. They represent precious memories of events, places and most significantly, relationships. However, people's photo collections are generally not well organized, and the retrieval of photos containing particular persons is very difficult. Today it is possible to convert photographs into digital images from prints or film to be stored on digital media such as the CD-ROM, or to capture images directly using a digital camera. These digital images are then transferred to the computer where they are analyzed to extract certain image features such as color, composition or texture. By specifying these features in a query, images can be retrieved. With available face detection and recognition technology, human faces can be located in digital images, and subsequently, recognized from a database of known faces. This technology can be used to organize images according to the faces they contain.

U.S. patent application 2001/0043727 A1, by Cooper, filed Sep. 30, 1998 and published Nov. 22, 2001, entitled Automatic Cataloging Of People In Digital Photographs discloses a technique for cataloging people in a digital images. The technique requires a user to enter identification parameter data during the cataloging of faces. There are also available content-based image retrieval software products for retrieving images from collections of images by the content, such as color, composition or texture. However, these low level image descriptions do not serve the purpose of organizing and retrieving images containing specific persons.

There is a need therefore for an improved method and system for automatically cataloging human faces in images.

### SUMMARY OF THE INVENTION

The need is met according to the present invention by providing a method and apparatus for organizing images of human faces in digital images into clusters, that: locates images of human faces in the digital images using a face detector; extracts the located human face images from the digital images; and forms clusters using a face recognizer of the extracted human face images, each cluster representing an individual.

### ADVANTAGES

The present invention has the advantage of providing a means of organizing images according to the human faces in them. It can be used to help consumers as well as professional photographers organize, sort and retrieve their images. Consumers can use it to organize their digital images according to faces, and retrieve images of certain persons in an efficient manner. This capability can be incorporated in the Picture CD software or in the digital camera transfer software, either in-camera or in the computer. Professional photographers can use this to organize images from an event, such as a wedding or a school photo session. The present invention can also help school photographers to keep track of students from year to year, eliminating the need to re-enter student information. Finally, photographers at theme parks can use the present invention to group images according to faces. The query in some cases can be a snapshot of one or more faces at the time of retrieval. The invention can be used to organize family image databases.

### BRIEF DESCRIPTION OF THE DRAWINGS

FIG. 1 is a flowchart of the method of the present invention;

FIG. 2 is a schematic diagram of a system on which the method of the present invention may be practiced;

FIG. 3 is a detailed flow chart of the method for face clustering according to the present invention;

FIG. 4 is a screen shot of a graphic user interface for user review and correction of face clusters; and

FIG. 5 is a screen shot of a graphic user interface for image retrieval using representative faces.

### DETAILED DESCRIPTION OF THE INVENTION

In the following description, a preferred embodiment of the present invention will be described in terms that would ordinarily be implemented as a software program. Those skilled in the art will readily recognize that the equivalent of such software may also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware and/or software for producing and otherwise processing the image signals involved therewith, not specifically shown or described herein, may be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, the computer program may be stored in a computer readable storage medium, which may comprise, for example; magnetic storage media such as a magnetic disk (such as a hard drive or a floppy disk) or magnetic tape; optical storage media such as an optical disc, optical tape, or machine readable bar code, solid state electronic storage devices such as random access memory (RAM), or read only memory (ROM); or any other physical device or medium employed to store a computer program.

Before describing the present invention, it facilitates understanding to note that the present invention is preferably utilized on any well-known computer system, such as a personal computer. Consequently, the computer system will not be discussed in detail herein. It is also instructive to note that the images are either directly input into the computer system (for example by a digital camera) or digitized before input into the computer system (for example by scanning an original, such as a silver halide film).

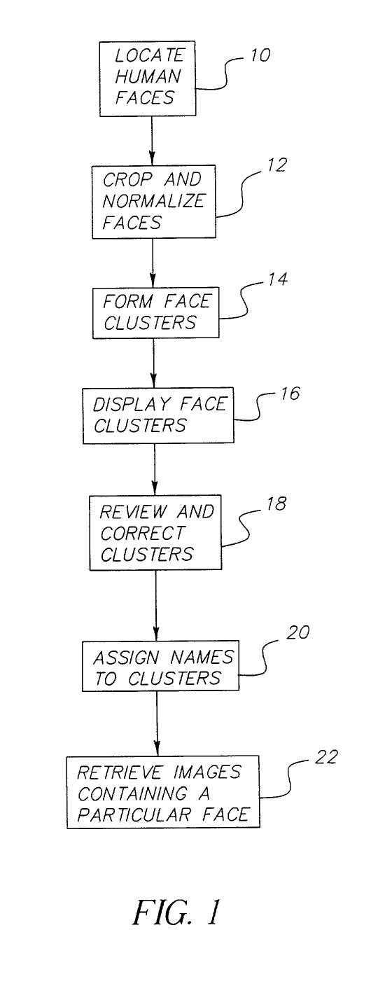

Referring to FIG. 1 first, human faces are located 10 in the digital images by a face detector. There are a number of known face detectors that can perform this function. In a preferred embodiment, the so-called algorithm S face detector described in U.S. Ser. No. 10/042,605 filed Jan. 9, 2002 by Nicponski, which is incorporated herein by reference, is used. Next, the facial regions are extracted 12 from the images and the size of the faces are normalized and the extracted faces are stored. Clusters of extracted faces are formed 14, according to their similarity, as described below in further detail. The face clusters are displayed 16 to a user for review and correction 18. After this, the user has the option to assign names 20 to each cluster. Finally, the user can retrieve images 22 containing a certain person by using a representative image or the name of the person.

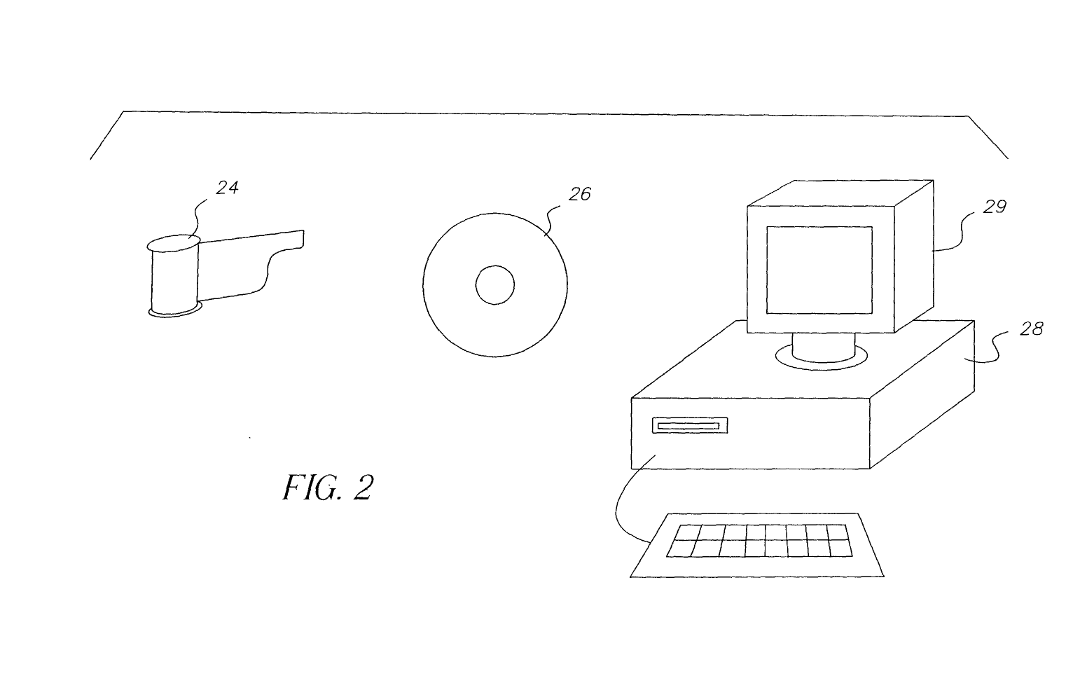

Referring to FIG. 2, digital images can be captured using a digital camera, or by capturing them on film 24 and scanning and digitizing the film images. According to a preferred embodiment, the film images are scanned and provided on a CD by a scanning service, such as the KODAK PICTURE CD service. Using the scanning service, the scanned images are stored on a CDROM 26 and returned to the user. The first time the KODAK PICTURE CD is inserted into a computer 28, a program on the CD automatically reads the images and displays them on a display 29 of the computer 28. The images can then be processed by the computer according to the present invention to identify and cluster images of human faces in the digital images.

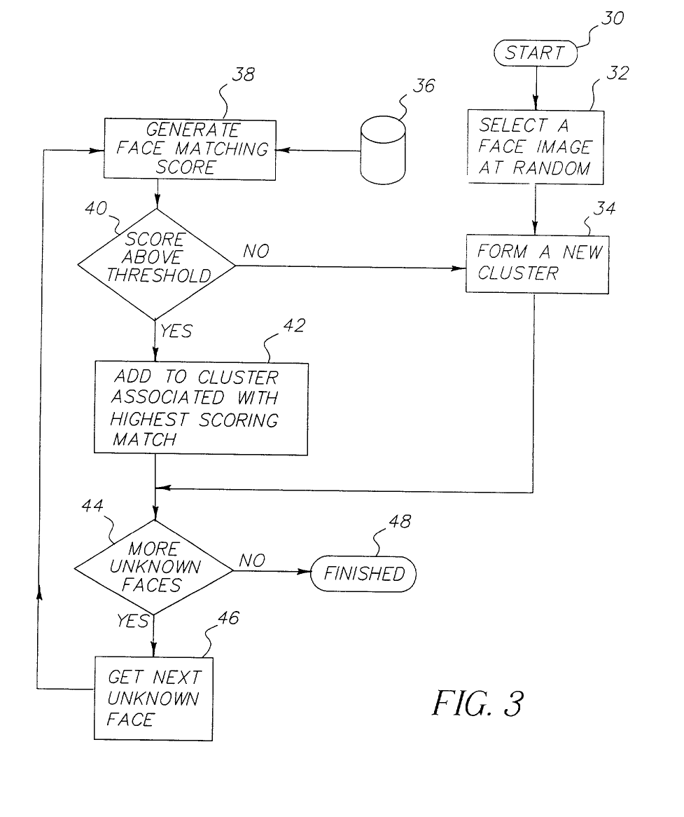

Referring to FIG. 3, the details of face clustering process 14 is described. At the start 30 there are no clusters containing facial images. An extracted face image is selected at random 32, and is used to form 34 a first cluster. Next, an unassigned face is fetched 46 from storage and compared to each face in any existing cluster of faces 36 to generate 38 a similarity score. The comparison is done by a face recognition program such as the Visionics FaceIt Software Developer's Kit (SDK). The similarity score(s) are compared 40 to a predetermined threshold, and if the score is below the predetermined threshold, a new cluster is formed 34 which contains the unassigned face. Otherwise, the unassigned face is added 42 to the cluster containing the face with the highest similarity score. The above process is repeated until a check 44 indicates that all faces have been assigned to a cluster, whereupon the process is finished 48.

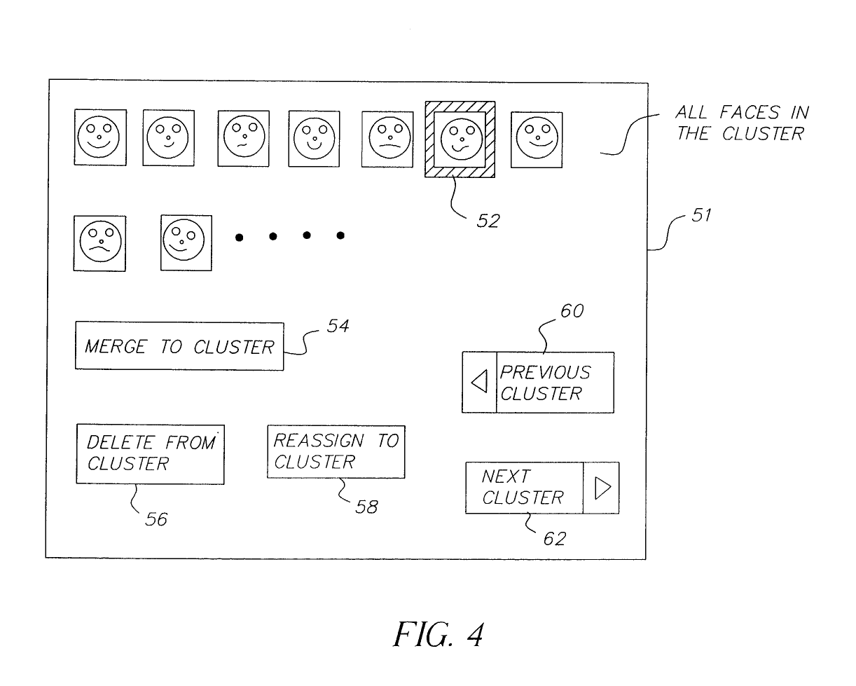

Referring to FIG. 4, a graphic user interface comprising a cluster review screen 51 is displayed on the computer display 29. A user can browse through all the face clusters by using buttons to the previous cluster 60, or to the next cluster 62. For each cluster, all the extracted face images contained in the cluster as determined by the clustering algorithm are displayed 50. If a face image does not belong to the cluster (e.g. face 52), the user has the option to either delete it from the cluster by clicking the button labeled “delete from cluster” 56, or reassign to another cluster X by entering a cluster number in the box labeled X and clicking button 58. If two clusters of faces belong together, the user can merge the cluster by indicating a cluster number in the box labeled Y and clicking the “merge to cluster” button 54 to merge the current cluster under review to the other cluster.

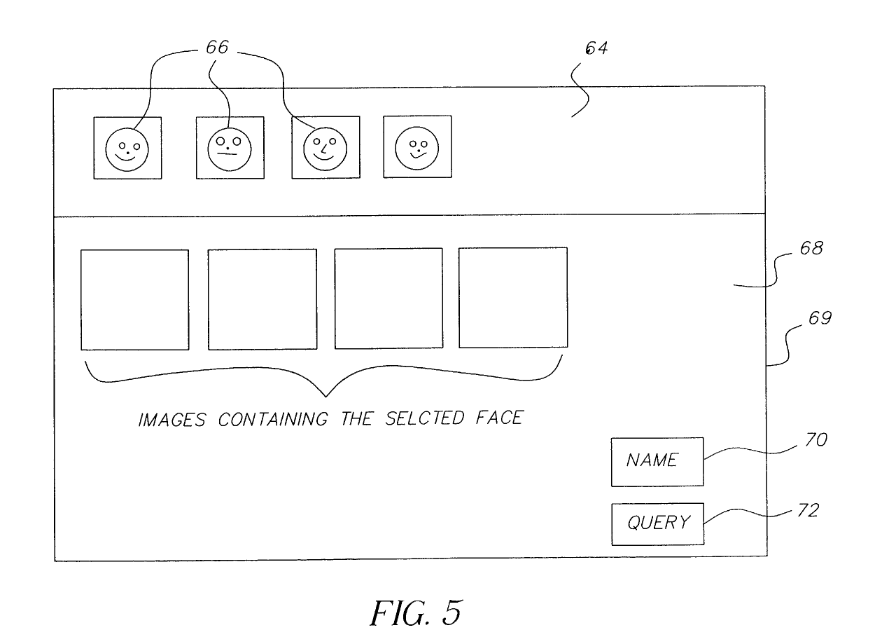

Referring to FIG. 5, a graphic user interface comprising the retrieval screen 69 is displayed on computer 29 A user is able to retrieve all images 68 containing the extracted faces in a given cluster. The top portion of the screen 64 shows a representative face image 66 for each cluster. When a cluster is selected by clicking on a representative face image, all digital images containing faces in the selected cluster are displayed 68.

Alternatively, names can be entered by the user into name fields 70 under each representative face to associate a name with each cluster. The digital images containing faces in a cluster can be retrieved by clicking on the name, or by entering a name in a query field 72.

The present invention can be used to organize family images by keeping only clusters having the most frequently occurring faces, which are most likely to be close family and friends, and discarding the other clusters.

The face clustering method of the present invention can be embodied in a program stored on the CD 26 for use by the CD user.

The invention has been described in detail with particular reference to certain preferred embodiments thereof, but it will be understood that variations and modifications can be affected within the spirit and scope of the invention.

PARTS LIST

| | |
|---|---|
| 10 | locate faces step |
| 12 | extract faces step |
| 14 | form clusters step |
| 16 | display face clusters step |
| 18 | review and correction step |
| 20 | assign names step |
| 22 | retrieve images step |
| 24 | photographic film |
| 26 | CD ROM |
| 28 | computer |
| 29 | display |
| 30 | start step |
| 32 | select face step |
| 34 | form first cluster step |
| 36 | face clusters |
| 38 | generate similarity score |
| 40 | compare score to threshold step |
| 42 | add face to cluster step |
| 44 | check for done step |
| 46 | fetch face step |
| 48 | process finished |
| 50 | display faces in cluster step |
| 51 | cluster review screen |
| 52 | face that doesn't belong to cluster |
| 54 | merge cluster button |
| 56 | delete from cluster button |
| 58 | reassign face button |
| 60 | previous cluster button |
| 62 | next cluster button |
| 64 | top portion of screen |
| 66 | representative face image |
| 68 | images containing faces in cluster |
| 69 | retrieval screen |
| 70 | name field |
| 72 | query field |

What is claimed is:

1. A method of organizing images of human faces in digital images into clusters, comprising the steps of:
a) locating images of human faces in the digital images using a face detector;
b) extracting the located human face images from the digital images; and
c) forming clusters of the extracted human face images, each cluster representing an individual using a face recognizer.

2. The method of claim 1, wherein the step of forming clusters comprises the steps of
i) choosing an extracted human face image and forming a first cluster containing the chosen human face image;
ii) selecting an extracted human face image that is not assigned to a cluster and comparing the selected human face image to all human face images in existing clusters using the face recognition program to produce a similarity score for each comparison;
iii) assigning the selected human face image to a cluster having a face with the highest similarity score above a predetermined threshold, otherwise forming a new cluster containing the selected human face image; and
iv) repeating steps ii) and iii) until all human face images are assigned to a cluster.

3. The method of claim 1, further comprising the step of displaying the clustered face images to a user.

4. The method of claim 1, further comprising the step of reviewing and correcting the assignment of the extracted face images to the clusters.

5. The method of claim 1, further comprising the step of selecting a representative face image from each cluster and employing the representative face image to retrieve all digital images containing a face image of the individual represented by the cluster.

6. The method of claim 5, further comprising the step of associating the name of an individual with each cluster and using the name to retrieve all of the digital images containing the named individual.

7. The method of claim 1, wherein the face detector is a face detection algorithm operating in a digital computer.

8. The method of claim 1, wherein the comparing step is performed by a face recognition algorithm operating on a computer.

9. The method claimed in claim 1, further comprising the step of keeping only those clusters having the most frequently occurring faces and discarding the other clusters.

10. The method claimed in claim 9, wherein the digital images are a collection of family digital images, wherein the most frequently occurring faces are likely to be those of family and friends.

11. A system for organizing images of human faces in digital images into clusters, comprising:
a) a digital image storage medium having digital images containing images of human faces;
b) a face detector for locating and extracting images of human faces in the digital images;
c) a face recognizer for forming clusters of the extracted human face images, each cluster representing an individual.

12. The system claimed in claim 11, wherein the face recognizer includes means for:
i) choosing an extracted human face image and forming a first cluster containing the chosen human face image;
ii) selecting an extracted human face image that is not assigned to a cluster and comparing the selected human face image to all human face images in existing clusters to produce a similarity score for each comparison;
iii) assigning the selected human face image to a cluster having a face with the highest similarity score above a predetermined threshold, otherwise forming a new cluster containing the selected human face image; and
iv) repeating steps ii) and iii) until all human face images are assigned to a cluster.

13. The system of claim 12, further comprising display means for displaying the clustered face images to a user.

14. The system of claim 12, further comprising a graphic user interface for reviewing and correcting the assignment of the extracted face images to the clusters.

15. The system of claim 12, further comprising a graphic user interface for selecting a representative face image from each cluster and employing the representative face image to retrieve all digital images containing a face image of the individual represented by the cluster.

16. The system of claim 15, wherein the graphic user interface further includes means for associating the name of an individual with each cluster and using the name to retrieve all of the digital images containing the named individual.

17. The system of claim 12, wherein the face detector is a facial detection algorithm operating in a digital computer.

18. The system of claim 12, wherein the face recognizer is a facial recognition algorithm operating on a computer.

19. A computer program product for performing the method claimed in claim 1.

20. The computer program product claimed in claim 19, wherein the product is a picture CD.
